(19) United States
(12) Patent Application Publication
(10) Pub. No.: US 2009/0144612 A1
(43) Pub. Date: Jun. 4, 2009

(54) DISPLAY OF DOCUMENT DATA

(75) Inventors: Takehiko Ishii, Kawasaki (JP); Tadayuki Yoshida, Yokohama (JP); Natsuki Zettsu, Yokohama (JP)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Machines Corporation, Armonk, NY (US)

(21) Appl. No.: 12/272,901

(22) Filed: Nov. 18, 2008

(30) Foreign Application Priority Data
Nov. 30, 2007 (JP) 2007-309708

(51) Int. Cl. G06F 17/00

(52) U.S. Cl. 715/234

(57) ABSTRACT

To locate a target document generated using a target language but other otherwise synchronized to a source document generated using a different source language, a URL or other document identifier for the source webpage is received and parsed to identify one or more elements; for example, a domain element or a path element. Each of the elements is analyzed to determine whether it includes one or more character strings associated with the source language; e.g., a language name, a language code, a country name and/or a country code. Each such character string is processed to generate a corresponding character string associated with the target language. A list of candidates for a second document identifier is generated and sequentially accessed to find the target document.

### BACKGROUND

The present invention generally relates to displaying document data, and more particularly to controlling the display of document data.

The globalization of communications made possible by the development and widespread adoption of the Internet and World Wide Web have created a demand for synchronization of content that is presented in different languages. For example, while a web page created using a Japanese language may be viewed by viewers around the world, many of those viewers may want to see the content of that web page presented accurately in a different language; for example, English or French. For convenience in the following description, a web page that includes text employing a particular language may be referred to as a “XX” web page where “XX” is the name of the language employed. As an example, a web page that uses characters expressed in a language of Japan may be referred to as a Japanese web page.

There is no known, suitable technique for synchronizing the content of a first web page that employs a first language with the content of a second web page that employs a second language. One known, but not suitable, technique for performing such synchronization is to first translate the contents of the first page from the first (or source) language into the second (or target) language and to build the second web page, maintaining the layout and visual impression of the first page as much as possible. Once the second web page is built, the language in the second web page is re-translated back to the source language. The re-translated content in the source language is then compared to the original content in the source language to determine whether there are any discrepancies.

Once the discrepancies are resolved, the web page that uses the target language must be associated or tied to the original web page. If the location of the original web page is changed, the location of the translated web page must be changed or the links between the two pages must be changed. When a plurality of browsers that are separately installed and do not share any components are used, different language settings can be configured for the individual browsers. Thus, the language setting need not be changed on the same browser. However, operations of changing web pages need to be performed for the individual browsers. When the operation is performed only once, the operation is not time-consuming. However, when the operation needs to be performed repeatedly, the operation is time-consuming and boring.

Similar problems can be pointed out in not only a case where web pages and content are displayed but also a case where general document data is displayed.

### SUMMARY

The present invention may be implemented as a computer-implemented apparatus for controlling the display of related documents using different languages. An accepting unit receives a first document identifier that includes language-related components associated with a first language. An obtaining unit processes the language-related components in the first document identifier to generate a second document identifier including language-related components associated with a second language. A control unit retrieves, for display at a second client, a second document identified by the generated second document identifier.

The present invention may also be implemented as a computer-implemented method for controlling the display of related documents using different languages. A first document identifier that includes language-related components associated with a first language is received. Language-related components in the first document identifier are processed to generate a second document identifier including language-related components associated with a second language. A second document is retrieved, for display at a second client, using the generated second document identifier.

The invention may also be implemented as a computer program product for controlling the display of related documents using different languages. The computer program product includes a computer usable medium embodying computer usable program code configured to receive a first document identifier having language-related components associated with a first language, computer usable program code configured to process the first document identifier to generate a second document identifier having language-related components associated with a second language, and computer usable program code configured to retrieve, for display at a second client, a second document identified using the generated second document identifier.

The best mode for carrying out the present invention (hereinafter called an embodiment) will now be described in detail with reference to the attached drawings. In the description of the present embodiment, it is assumed that web pages are viewed using the HTTP protocol. However, the description is illustrative of the present invention and is not to be construed as limiting the present invention to a specific protocol or a specific object to be displayed. That is to say, the present embodiment is also applicable to a case where any document data is displayed using any protocol.

### BRIEF DESCRIPTION OF THE SEVERAL VIEWS OF THE DRAWINGS

FIG. 1 shows components of and message flows in computer system implementing the present invention.

FIG. 2 shows a display image of an example browser window.

FIG. 3 is a block diagram showing functional components of an agent 20.

FIG. 4 shows an operation of registering browsers in accordance with an embodiment of the present invention.

FIG. 5 shows a first operation performed when pages are synchronized and displayed in accordance with an embodiment of the present invention.

FIG. 6 shows a second operation performed when pages are synchronized and displayed in accordance with an embodiment of the present invention.

FIG. 7 shows a third operation performed when pages are synchronized and displayed in accordance with an embodiment of the present invention.

FIG. 8 shows a fourth operation performed when pages are synchronized and displayed in accordance with an embodiment of the present invention.

FIG. 9 shows a fifth operation performed when pages are synchronized and displayed in accordance with an embodiment of the present invention.

FIG. 10 shows a first operation performed when a URL that is determined as being valid is found to be incorrect in accordance with an embodiment of the present invention.

FIG. 11 shows a second operation performed when a URL that is determined as being valid is found to be incorrect in accordance with an embodiment of the present invention.

FIG. 12 shows a third operation performed when a URL that is determined as being valid is found to be incorrect in accordance with an embodiment of the present invention.

FIG. 13 shows a fourth operation performed when a URL that is determined as being valid is found to be incorrect in accordance with an embodiment of the present invention.

FIG. 14 is a flowchart showing an exemplary operation of the agent in the embodiment of the present invention.

FIG. 15 is a flowchart showing an example of a first process in generating a URL candidates list in accordance with an embodiment of the present invention.

FIG. 16, consisting of FIGS. 16(a) and 16(b) considered together, shows exemplary conversion rules used in the first process in generating a URL candidates list in accordance with an embodiment of the present invention.

FIG. 17 shows exemplary URL element candidates generated in accordance with an embodiment of the present invention.

FIG. 18 is a flowchart showing an example of a second process in generating a URL candidates list in accordance with an embodiment of the present invention.

FIG. 19-1 shows examples of combination rules used in the second process in generating a URL candidates list in accordance with an embodiment of the present invention.

FIG. 19-2 shows examples of combination rules used in the second process in generating a URL candidates list in accordance with an embodiment of the present invention.

FIG. 20 shows an example of a URL candidates list generated in accordance with an embodiment of the present invention.

FIG. 21 shows the hardware configuration of a computer in which an embodiment of the present invention may be implemented.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

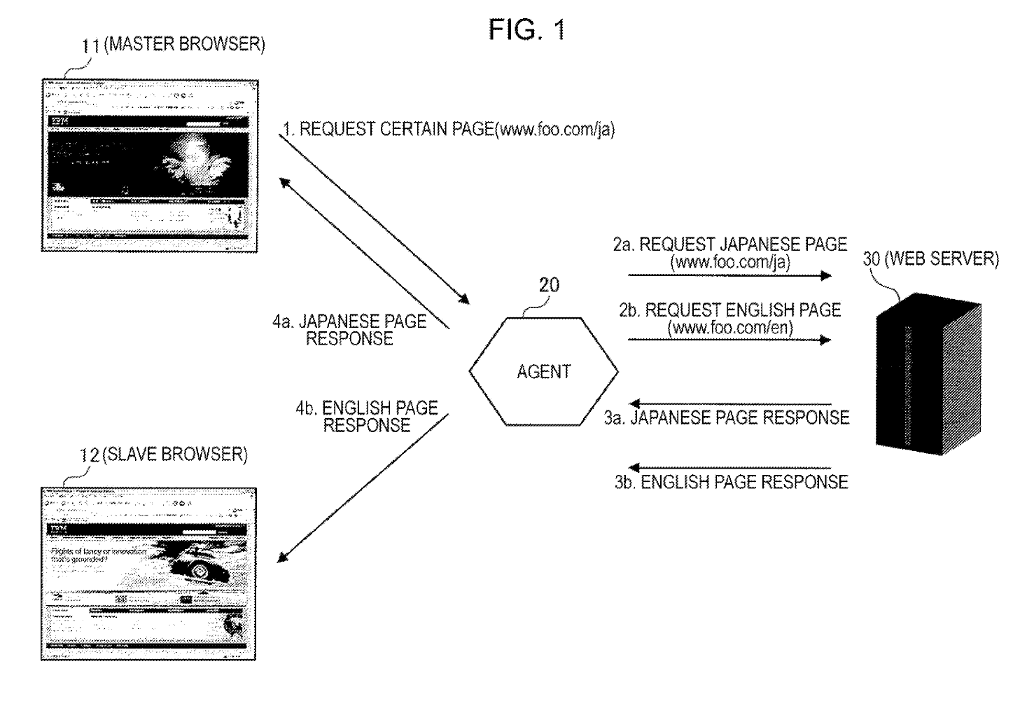

FIG. 1 shows components of and message flows in a computer system implementing the present invention. The computer system includes a master browser 11, a slave browser 12, an agent 20, and a web server 30.

The master browser 11 is a browser program instance created when a user activates a web browser to retrieve and display a web page in a window (hereinafter called a master browser window) with the web page having content presented in a particular language.

The slave browser 12 is a different browser program instance created to display a web page having content presented in another language. The content of the page displayed by the slave browser 12 is intended to be synchronized with the content of a page displayed in the master browser window. While a single slave browser 12 is shown, a plurality of slave browsers 12 may exist concurrently in the system.

The master browser 11 and the slave browser 12 may operate on the same computer terminal or on different computer terminals. While, in this case, two pages to be synchronized are displayed in separate browser windows, the two pages to be synchronized may be displayed in multiple areas (for example, behind tabs) in a single browser window.

The agent 20 manages a plurality of browsers (in this case, the master browser 11 and the slave browser 12) and, in response to a user input, requests a desired page from the web server 30. The agent 20 may operate on one of the computer terminals that instantiates either the master browser 11 and/or the slave browser 12 or may operate on still another computer terminal.

The web server 30 may be a single server that stores sets of web pages where each set includes multiple web pages having the same content represented in a plurality of languages. Alternatively, the web server may include one or more sets of web pages where all of the pages in a particular set use a particular language. While the web server 30 is represented as a single logical server, it should be understood the single logical server could be implemented by one or more physical servers.

In the present embodiment, operations to be described below are performed in the computer system. For purposes of illustration, it is assumed that the master browser 11 displays a Japanese page while slave browser 12 displays an English page (i.e., a page in which text is displayed in English).

When a user requests the display of a page in the master browser window, the master browser 11 requests the page from the agent 20 (message flow 1). The agent 20 requests a Japanese page (request 2a) and a corresponding English page (request 2b) from the web server 30 in response to the user request. The web server 30 returns the Japanese page (response 3a) and the English page (response 3b) as responses corresponding to the requests 2a and 2b. Then, the agent 20 forwards the Japanese page to the master browser 11 (response 4a) and the English page to the slave browser 12 (response 4b). The Japanese page and the English page are concurrently displayed in the master browser window and the slave browser window, respectively.

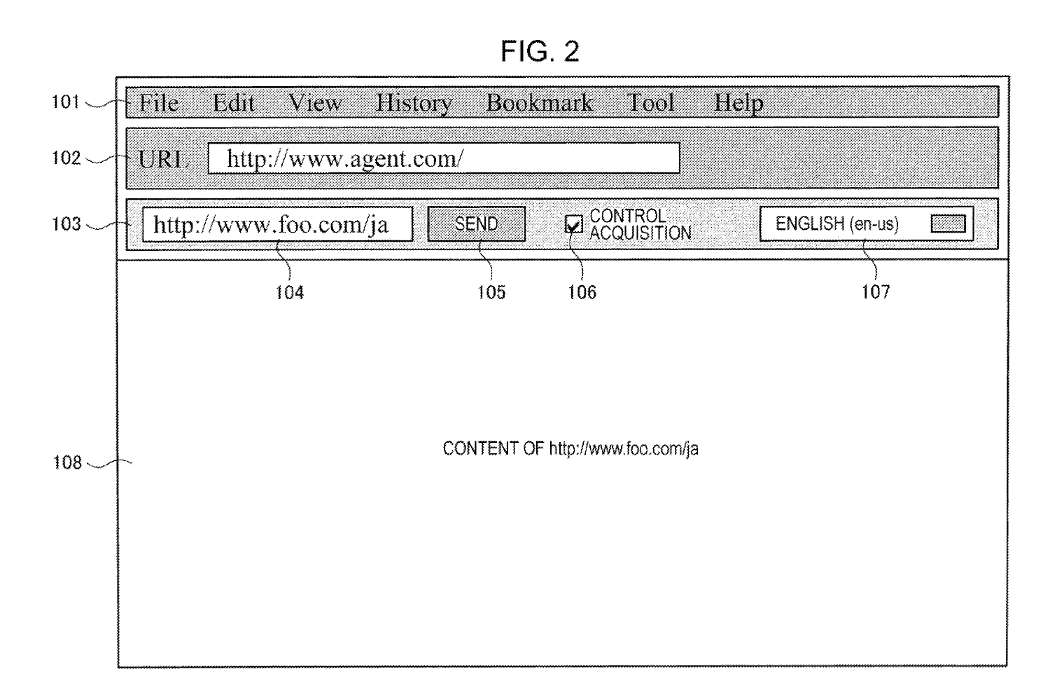

Details of an example of a browser window displayed by the master browser 11 or the slave browser 12 will now be described with reference to FIG. 2.

A menu bar 101 of the type generally seen in many windows appears near the upper edge of the browser window. An address bar 102 for entering a uniform resource locator (URL) appears under the menu bar 101. In the present embodiment, the URL of the agent 20 is entered in the URL entry field in the address bar 102. A custom toolbar 103 for transferring information to the agent 20 appears under the address bar 102. The custom toolbar 103 includes a URL entry box 104, a send button 105, a control acquisition check box 106, and a language selection list box 107.

In the master browser window, the URL entry box 104 enables entry of the URL of a page with which a corresponding page is to be synchronized. In the slave browser window, the same URL entry box 104 may be used to allow a browser user to enter the URL of a different web page when the supposedly corresponding page provided by the system does not, in fact, correspond to the original web page.

The send button 105 is a button that is pressed to indicate a URL entered in the URL entry box 104 is to be sent to the agent 20. The control acquisition check box 106 is a box that is used to establish browser roles. A master browser is designated by selecting the control acquisition check box 106 while a slave browser is designated by leaving the control acquisition check box 106 unselected.

The language selection list box 107 is a list box that is used to specify the language of a page to be displayed in the corresponding browser window. For example, when English is selected from the language selection list, as shown in the drawing, an English page should appear in the browser window. A content display area 108 for displaying content obtained from the agent 20 is provided below the custom toolbar 103.

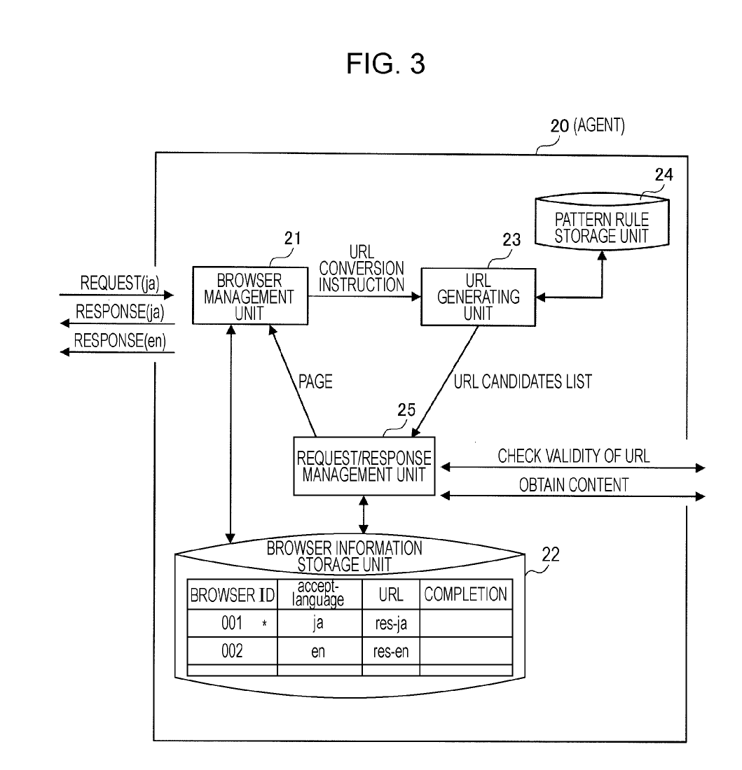

The functional components of the agent 20 shown generally in FIG. 1 will now be described with reference to FIG. 3. The agent 20 includes a browser management unit 21, a browser information storage unit 22, a URL generating unit 23, a pattern rule storage unit 24, and a request/response management unit 25.

The browser management unit 21 uses stored files, for example, cookies to identify a plurality of browsers. The browser management unit 21 controls the language in which a page is displayed in each of the browsers. It is assumed here that the master browser 11 displays a Japanese page and the slave browser 12 displays an English page. To accomplish this, the browser management unit 21 first accepts a request from master browser 11 with the request including a URL identifying a Japanese page that a user wishes to display in the master browser window. The browser management unit 21 then sends a URL conversion instruction to the URL generating unit 23. The URL generating unit 23 converts the URL accepted from the master browser to a second URL intended to identify what is believed is a corresponding English page. Upon receiving the Japanese page and the English page returned from the request/response management unit 25, the browser management unit 21 sends the Japanese page to the master browser 11 and the English page to the slave browser 12.

A user will typically have access to a plurality of browsers. The browser information storage unit 22 stores browser IDs, accept-language, URLs, and completion flags correlated with each other. A browser ID contains identification information uniquely identifying a particular browser and a template for identifying clients capable of using that particular browser. For purposes of illustration, a browser ID value of 001 is assigned to the master browser 11 while a browser ID of 002 is assigned to the slave browser 12. Also for purposes of illustration, a master browser is identified by appending a suitable indicator; e.g., “*” to the browser ID value. In the present embodiment, the agent 20 manages the master-slave relationship between browsers.

Only one group of browsers having a master-slave relationship is illustrated. Multiple groups of browsers, each group having master-slave relationships, may exist. In the latter case, a master browser ID field may be added to the browser information storage unit 22. Then, a group may be searched for using a master browser ID as a key. As an example, assume that slave browser IDs 002 and 003 correspond to a master browser ID 001 while slave browser IDs 005, 006 and 007 correspond to a master browser ID 004. In this case, the master browser IDs 001, 001, 001, 004, 004, 004, and 004 respectively corresponding to browser IDs 001, 002, 003, 004, 005, 006, and 007 are stored. A group that includes the browser IDs 001, 002, and 003 is identified using the master browser ID 001 as a key, and a group that includes the browser IDs 004, 005, 006, and 007 is identified using the master browser ID 004 as a key.

Accept-language is information indicating which language is required for a page that is to be displayed in a particular browser window regardless of the language setting in a corresponding browser. That is to say, the browser language setting included in the header of an HTTP request sent from the browser to the agent 20 can be replaced with the accept-language value stored in the browser information storage unit 22. A browser ID and accept-language are set when a corresponding browser is registered.

URLs are set as the result of processing described below in the URL generating unit 23 and in the request/response management unit 25 and are identifiers for pages that are to be displayed by individual browsers. In practice, the character strings of URLs are stored. For purposes of illustration here, the URL of a Japanese page is represented as “res-ja” and the URL of an English page is represented as “res-en”.

A completion flag value is a value indicating whether acquisition of a page based on a URL stored in the URL field is completed. When acquisition of a page is completed, a “Y” value is assigned to the completion flag. When acquisition of a page is not yet completed, an “N” value is assigned to the completion flag. In the drawing, the completion flag is represented as a “completion” column.

Browser information storage unit 22 is a storage unit that stores information correlating a browser ID to completion determination information.

The function of URL generating unit 23 is, beginning with the original URL received from the master browser, to generate a list of possible or candidate URLs for the web page that is to be displayed on the slave browser. The list of candidate URLs is generated in accordance with a URL conversion instruction sent from the browser management unit 21. In the embodiment being described, the URL generating unit 23 uses pattern rules described below in generating the list of candidate URLs. The URL generating unit 23 sends the list of candidate URLs to the request/response management unit 25.

As will be described in more detail below, the pattern rule storage unit 24 stores pattern rules that are used to generate a list of candidate URLs in the URL generating unit 23.

The request/response management unit 25 receives a list of URL candidates from the URL generating unit 23 and checks the validity of individual URLs included in the list. Assuming that at least one of the candidate URLs satisfies validity requirements, the request/response management unit 25 obtains a page from the web server 30 (refer to FIG. 1) at the address specified by the valid candidate URL.

Operations in the agent 20 will now be described. It is assumed that the user knows in advance that pages in target languages (for example, English and Japanese) are stored in sites that can be accessed, but the user does not know the address structures of pages stored in those sites. Moreover, it is assumed that, when acquisition of an acceptable page in another language fails, the user can determine and indicate a correct URL in a predetermined manner.

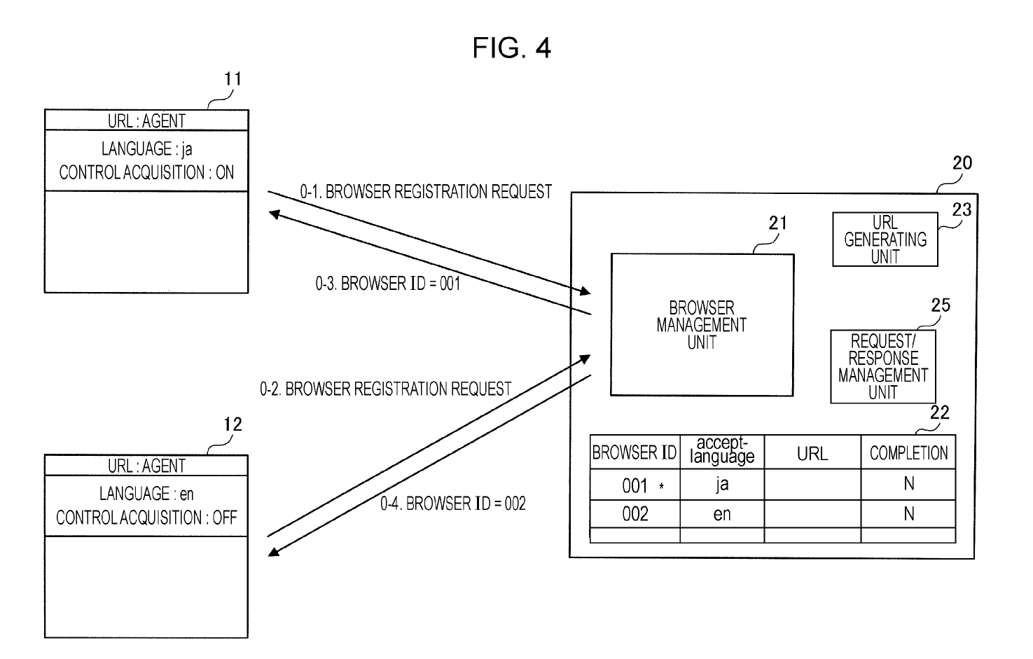

An operation of registering individual browsers in the agent 20 will first be described with reference to FIG. 4. The master browser 11 sends a registration request to the agent 20 (request 0-1). The control acquisition check box 106 shown in FIG. 2 will have been previously selected to identify the browser from which a registration request is sent as the master browser 11. In the drawing, the master browser 11 also indicates to the agent 20 that a Japanese page needs to be displayed. The slave browser 12 also sends a registration request to the agent 20 (request 0-2). In the drawing, the slave browser 12 indicates to the agent 20 that an English page corresponding to the previously-identified Japanese page needs to be displayed.

In the agent 20, the browser management unit 21 assigns a unique browser ID to each of the browsers. Then, the browser management unit 21 registers, in browser information storage unit 22, the correlation between the browser IDs of the individual browsers and the languages of pages to be displayed by the individual browsers. In this case, browser ID 001 is assigned to the master browser 11, and browser ID 002 is assigned to the slave browser 12. Thus, the correspondence between the browser ID 001 and “ja” representing Japanese and the correspondence between the browser ID 002 and “en” representing English are registered. In this case, “*” indicates that the corresponding browser is a master browser.

The browser management unit 21 in agent 20 sends the browser ID 001 to the master browser 11 (response 0-3) and the browser ID 002 to the slave browser 12 (response 0-4).

In the present embodiment, when a browser registration request is sent to the agent 20, master and slave browsers are determined by reference to additional information indicating whether control acquisition is enabled for the browsers. Alternatively, an existing master-slave relationship may be updated to newly designate master and slave browsers by reference to additional control acquisition information when a page to be displayed is requested, as described below. An embodiment in which the role of the master browser may be changed in this way every time a page is requested may be adopted.

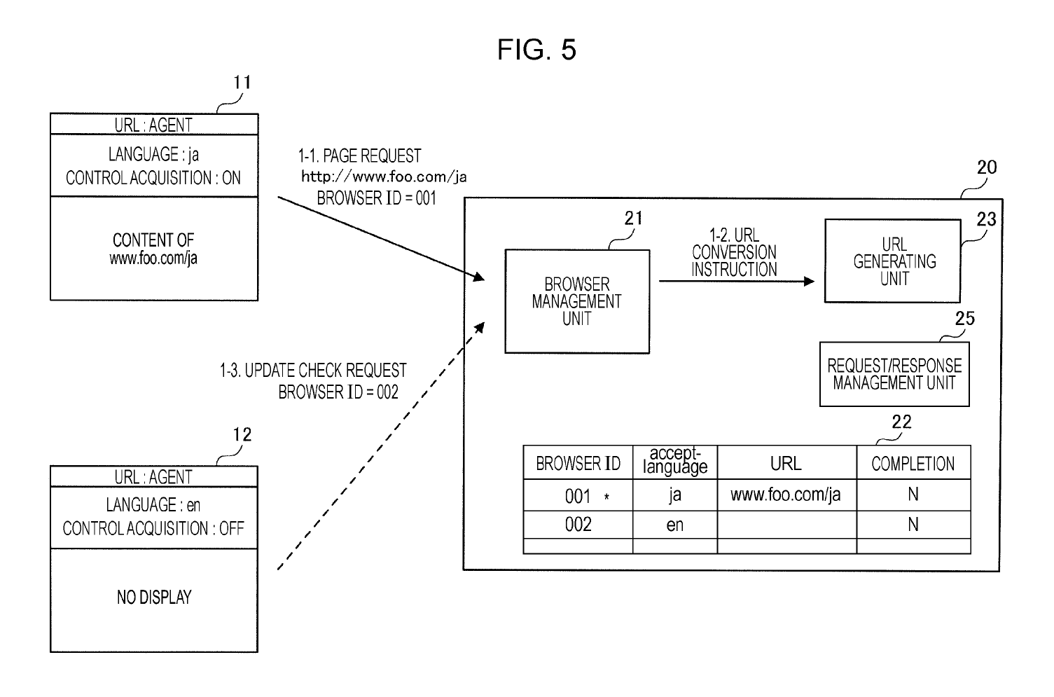

Operations performed between the time when the master browser 11 requests a page from the agent 20 and the time when the master browser 11 and the slave browser 12 display corresponding pages in different languages will now be described with reference to FIGS. 5-9.

An operation of requesting a page from the agent 20 by the master browser 11 will first be described with reference to FIG. 5. The master browser 11 sends the agent 20 the URL of a page that needs to be displayed (request 1-1). The master browser 11 also sends the browser ID of the master browser 11 to the agent 20, using, for example, a cookie. In the drawing, the master browser 11 sends a URL “http://www.foo.com/ja” and the browser ID 001 to the agent 20.

The browser management unit 21 in agent 20 stores the received URL in association with the browser ID in the browser information storage unit 22. The browser management unit 21 recognizes with reference to the browser information storage unit 22 that the language displayed by the master browser 11 is Japanese, and the language displayed by the slave browser 12 is English. Then, the browser management unit 21 sends the URL generating unit 23 a URL conversion instruction to convert the original URL provided from the master browser 11 to a different URL that may identify a stored English page (1-2) corresponding (synchronized) to the Japanese web page identified by the original URL.

The slave browser 12 sends an update check request to the agent 20 at short intervals of, for example, one second (request 1-3). The update check request provides a periodic query as to whether the requested corresponding English page has been identified and retrieved. In this case, the slave browser 12 also sends the agent 20 the browser ID of the slave browser 12 using, for example, a cookie.

Then, in the agent 20, the browser management unit 21 determines with reference to the browser information storage unit 22 whether the completion flag for the browser ID received from the slave browser 12 is set to “Y”. Initially, the agent 20 could not have obtained a corresponding English page and the completion flag for the browser ID 002 will be found to be set to “N”. Thus, the browser management unit 21 does not send any page to the slave browser 12.

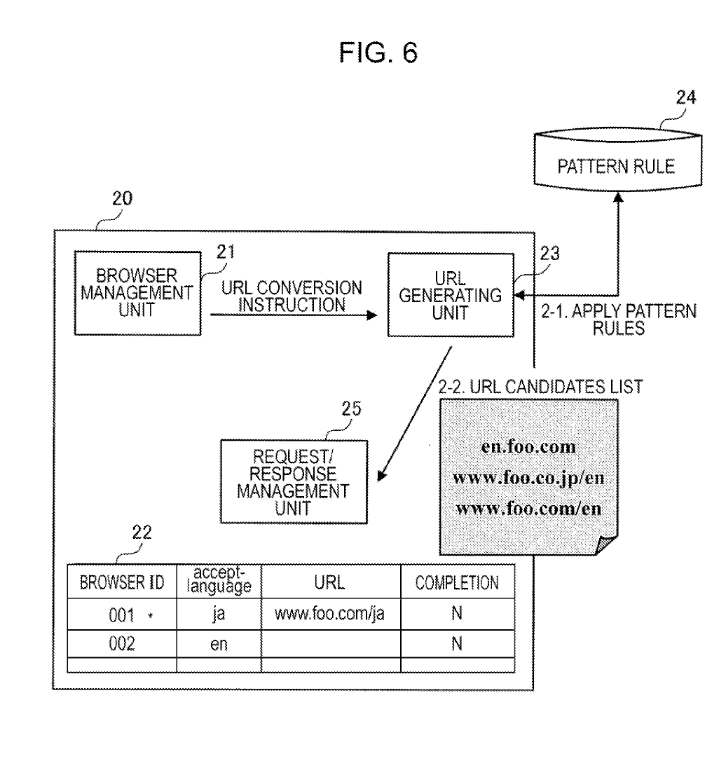

Next, an operation of generating a list of URL candidates by the agent 20 will be described with reference to FIG. 6. In the agent 20, the browser management unit 21 has sent the URL generating unit 23 a URL conversion instruction to convert an original URL identifying a Japanese page to a candidate URL that identifies an English page.

The URL generating unit 23 generates a list of URL candidates list by using pattern rules stored in the pattern rule storage unit 24 (operation 2-1). For example, when an original web page uses Japanese and the target web page is to use English, URLs are generated by, in part converting occurrences of “ja” in the original URL to occurrences of “en” in candidate URLs. Then, the URL generating unit 23 transfers the generated list of URL candidates to the request/response management unit 25 (operation 2-2).

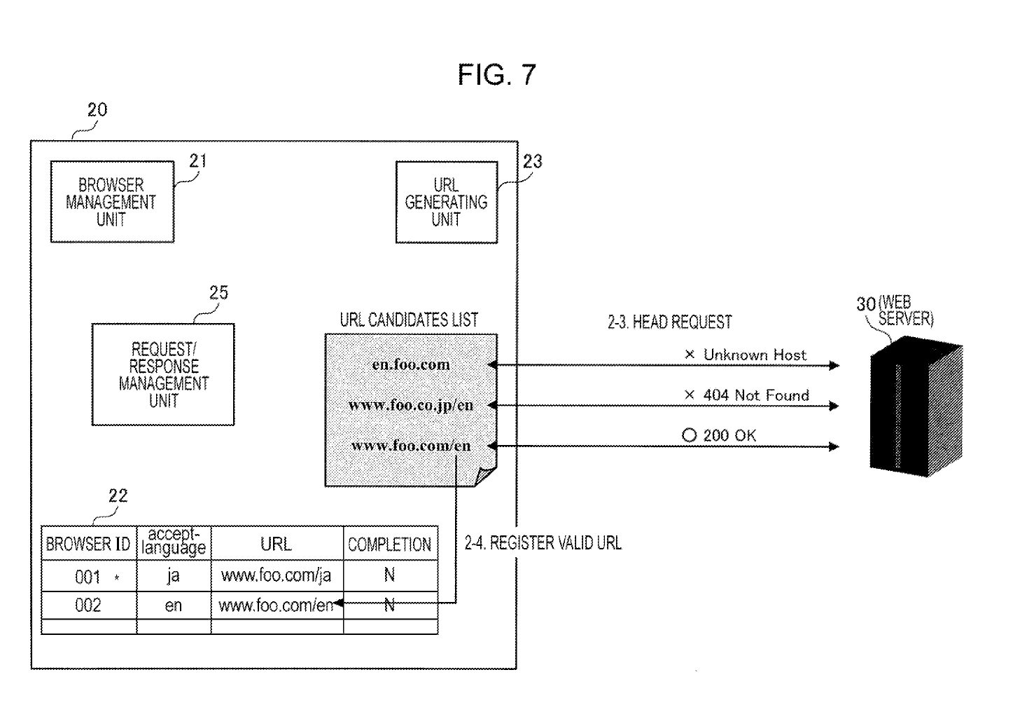

An operation for checking the validity of individual URLs included in a list of URL candidates will be described with reference to FIG. 7. In the agent 20, the request/response management unit 25 sends a HEAD request to the web server 30 on the basis of the individual URLs included in the list of URL candidates (operation 2-3). A HEAD request is a request by the HEAD method among HTTP requests. In this case, it is assumed that, the higher the ranking of a particular URL in the list of URL candidates, the higher its priority. Moreover, it is assumed that, among the URLs included in the list of URL candidates, “en.foo.com” and “www.foo.co.jp/en” do not exist, while “www.foo.com/en” may exist. A HEAD request is first sent to “en.foo.com”. Since a status “Unknown Host” is returned in response to the HEAD request, it is found that “en.foo.com” is not a valid URL. Then, a HEAD request is sent to “www.foo.co.jp/en”. Since a status “404 Not Found” is shown being returned in response to the HEAD request, it is concluded that “www.foo.co.jp/en” is not a valid URL. Finally, when a HEAD request is sent to “www.foo.com/en”, a status “200 OK” is returned in response to the HEAD request. Thus, it is concluded that “www.foo.com/en” is a valid URL.

Then, the request/response management unit 25 stores the URL “www.foo.com/en”, which has been determined to be valid, in association with the browser ID 002 of the slave browser 12 in the browser information storage unit 22 (operation 2-4).

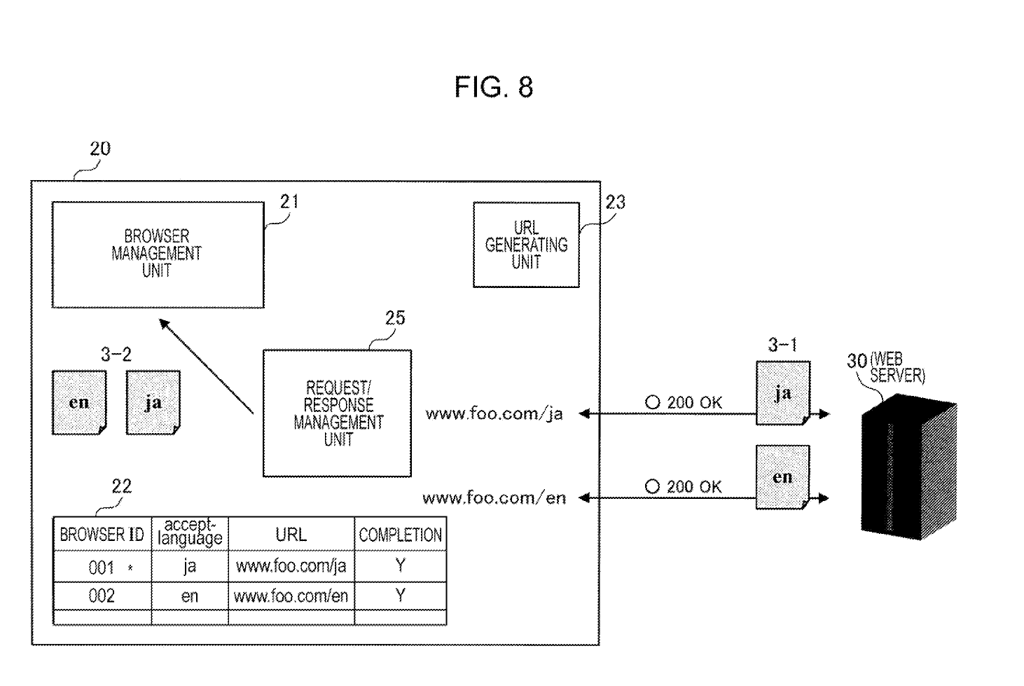

An operation of obtaining responses from an original URL and a valid candidate URL will be described with reference to FIG. 8. In the agent 20, the request/response management unit 25 retrieves URLs registered in the browser information storage unit 22 corresponding to the browser IDs of individual browsers, as shown in the drawing. In this case, “www.foo.com/ja” is retrieved as a URL (an original URL) correlated to the browser ID 001, and “www.foo.com/en” is retrieved as a URL (a valid candidate URL) correlated to the browser ID 002. Then, the request/response management unit 25 obtains pages from the web server 30 on the basis of these URLs (operation 3-1). In this case, since both of the URLs are valid, the status “200 OK” is returned for both, and pages are obtained at the URLs. The request/response management unit 25 transfers the obtained pages to the browser management unit 21 (3-2). When the request/response management unit 25 transfers the obtained pages to the browser management unit 21, the request/response management unit 25 sets the completion flag for the browser ID 001 and the completion flag for the browser ID 002 to “Y” in the browser information storage unit 22.

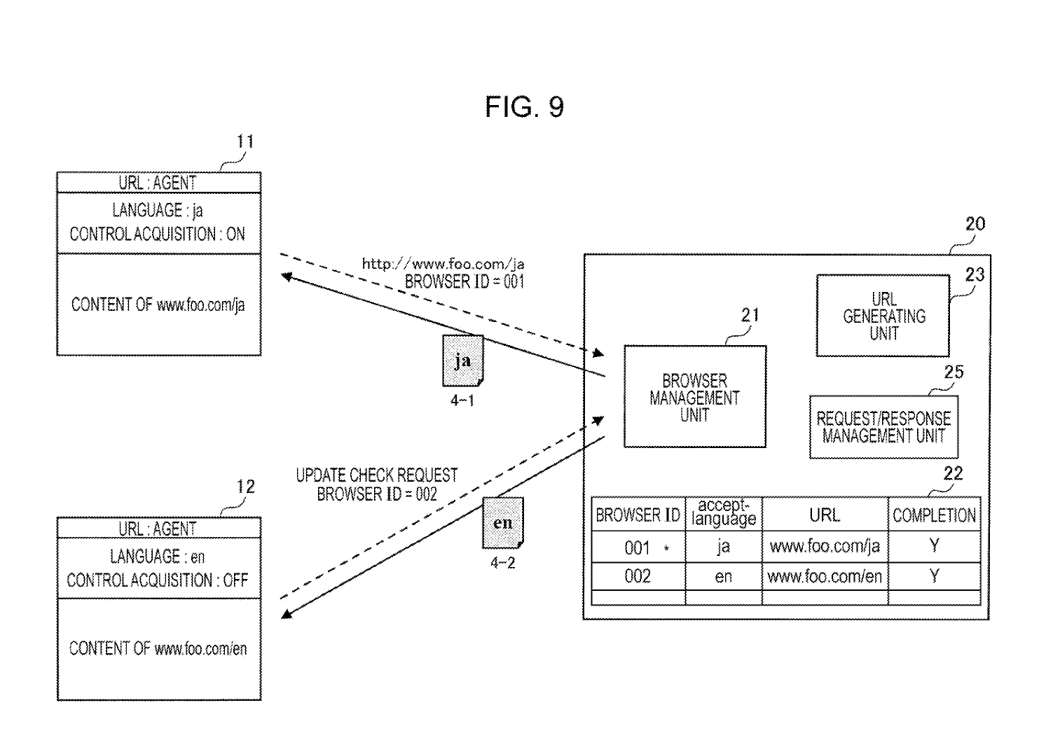

An operation of returning responses to the master browser 11 and the slave browser 12 will be described with reference to FIG. 9. In the agent 20, the browser management unit 21 sends a Japanese page to the master browser 11 (reply 4-1). A dashed line extending from the master browser 11 to the browser management unit 21 represents the page acquisition request shown in FIG. 5. The browser management unit 21 also sends an English page to the slave browser 12 (reply 4-2). A dashed line extending from the slave browser 12 to the browser management unit 21 represents the update check request shown in FIG. 5. In the system state described with reference to FIG. 5, the update check request would have no effect since the completion flag for the browser ID 002 was still set to “N” in the browser information storage unit 22. However, since the completion flag for the browser ID 002 will have been set to “Y” by processes shown in FIGS. 6 to 8, a page is sent in response to an update check request occurring in the system state represented in FIG. 9.

In general, a browser does not issue any request without the user's input. When no request is issued, no information is displayed because the recipient cannot be determined. Thus, in the present embodiment, the slave browser 12 periodically sends an update check request to the agent 20 so as to retrieve a page for display in the slave browser 12. In this case, the slave browser 12 emulates a user-initiated request through the periodic automatic generation of update check requests. When a plurality of the slave browsers 12 exist, a plurality of responses can be returned to the individual browsers without having a user of each of those browsers manually enter a request.

Moreover, in this case, a method for indicating by a completion flag whether acquisition of a page is completed is adopted as a method for indicating whether a page to be displayed by the slave browser 12 has already been retrieved. Methods other than use of a completion flag may be adopted for storing an indication that a page to be displayed by the slave browser 12 has been retrieved.

Moreover, in this case, actual web pages have been described as being sent to the master browser 11 and the slave browser 12. However, the actual web pages need not necessarily sent. As an alternative, the agent 20 may send only the URLs of the web pages to the individual browsers, and the individual browsers may obtain the pages without the intervention of the agent 20.

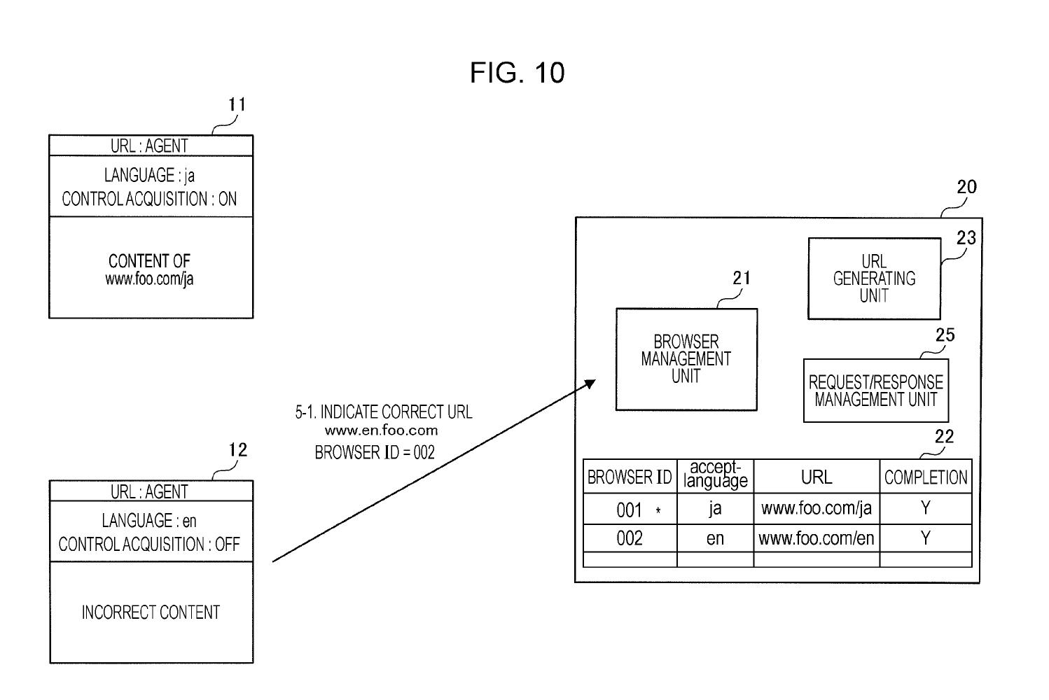

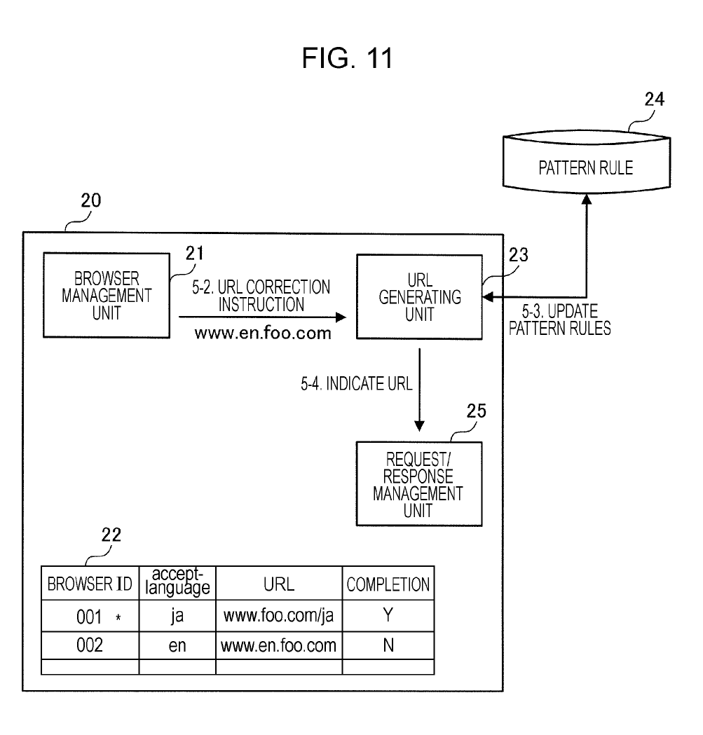

The goal of the process is for the slave browser 12 to display a target web page that corresponds to (is synchronized with) a source web page except that the source web page uses a first or source language while the target web page uses a second or target language. The possibility exists that target web page retrieved using a generated candidate URL, even one which appears to be valid, may in fact not correspond to the source web page. In such a case, the agent 20 changes pattern rules in response to input of a correct URL by the user. Operations performed in this case will now be described. FIGS. 10 to 13 show the flows of the operations.

An operation of indicating a correct URL to the agent 20 by the slave browser 12 will first be described with reference to FIG. 10. The slave browser 12 sends a correct URL to the agent 20 (operation 5-1). The slave browser 12 also transfers the browser ID of the slave browser 12 to the agent 20. In the drawing, a correct URL “www.en.foo.com” together with the browser ID 002 is shown being transferred to the agent 20. The browser management unit in the agent 20 accepts the URL from the slave browser and returns an acknowledgment (not shown) of the URL correction request. At the same time, the browser management unit 21 resets the completion flag for the browser ID 002 in the browser information storage unit 22 to “N” to indicate the slave browser has not, in fact, yet received the desired web page.

An operation of updating pattern rules by the agent 20 will be described with reference to FIG. 11. The browser management unit 21 sends the URL generating unit 23 a URL correction instruction (operation 5-2) to replace the URL of the page previously sent to the slave browser 12 with the correct URL just received from the slave browser. Specifically, the browser management unit 21 sends the URL generating unit 23 the correct URL “www.en.foo.com” obtained from the slave browser 12. The URL generating unit 23 updates pattern rules in response to the URL correction instruction (operation 5-3). In this case, pattern rules may be updated by correlating the correct URL sent from the browser management unit 21 directly with the URL originally received from the master browser 11, or by adjusting the order of application of pattern rules on the basis of the URL sent from the browser management unit 21. When updating of pattern rules is completed, the URL generating unit 23 indicates the correct URL to the request/response management unit 25 (operation 5-4). At that time, the request/response management unit 25 stores the indicated URL in association with the browser ID 002 of the slave browser 12 in the browser information storage unit 22.

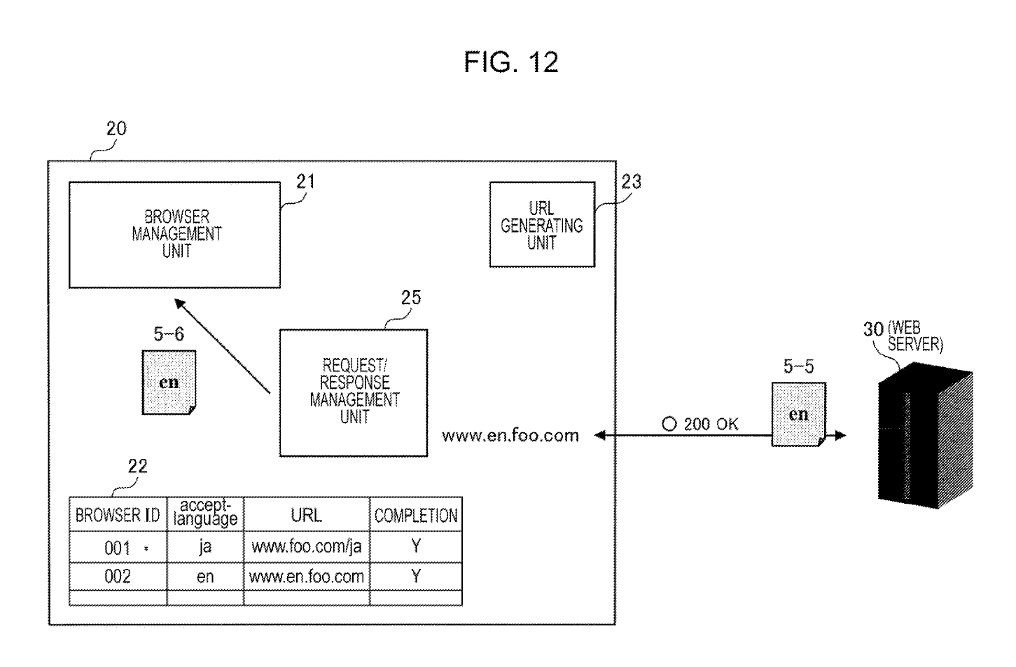

An operation of obtaining a response to a corrected URL will be described with reference to FIG. 12. In the agent 20, the request/response management unit 25 retrieves the URL registered for the slave browser 12 in the browser information storage unit 22. In the illustrated case, the request/response management unit 25 retrieves “www.en.foo.com” as a URL correlated to the browser ID 002. Then, the request/response management unit 25 obtains a page from the web server 30 on the basis of the URL (operation 5-5). Since the URL is a valid URL, the status “200 OK” is returned, and a page is retrieved and transferred to the browser management unit 21 (operation 5-6). When the retrieved page is transferred to the browser management unit 21, the request/response management unit 25 sets the completion flag stored in the browser information storage unit 22 to “Y”.

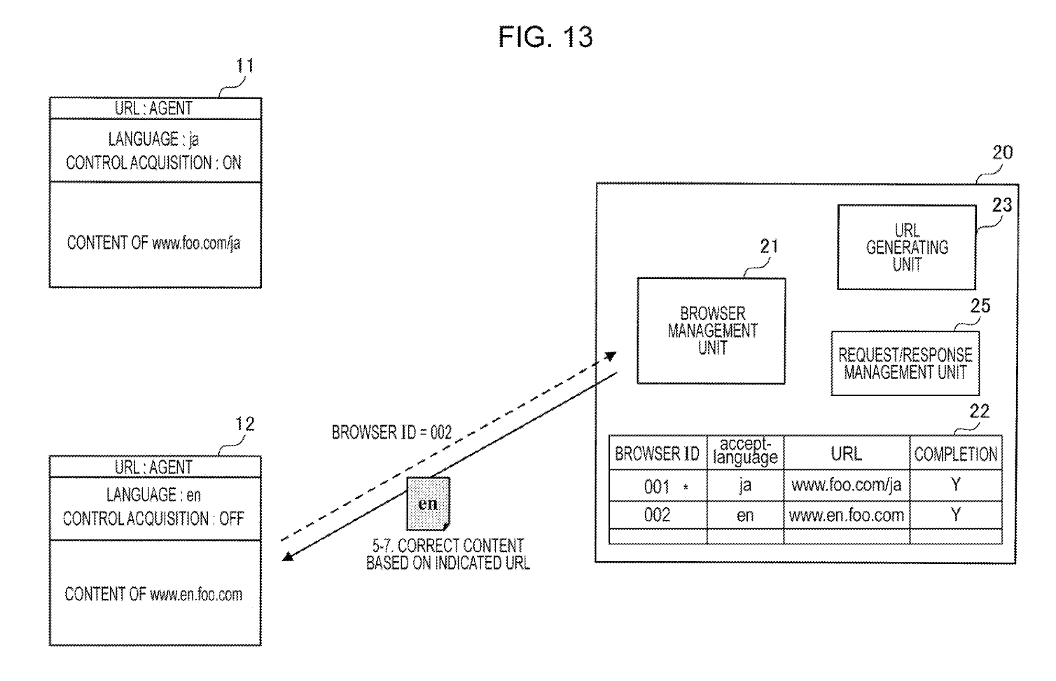

An operation of returning a response to the slave browser 12 will be described with reference to FIG. 13. The browser management unit 21 sends the slave browser 12 a correct page based on the indicated URL (operation 5-7). A dashed line extending from the slave browser 12 to the browser management unit 21 represents the previously-discussed update check request. In this arrangement, the browser management unit 21 sends the slave browser 12 the page of “www.en.foo.com”, which is a correct URL, and the slave browser 12 displays the page.

As previously noted, the agent 20 may alternatively send only the URL of the page to the slave browser 12, and the slave browser 12 may obtain the page without the intervention of the agent 20.

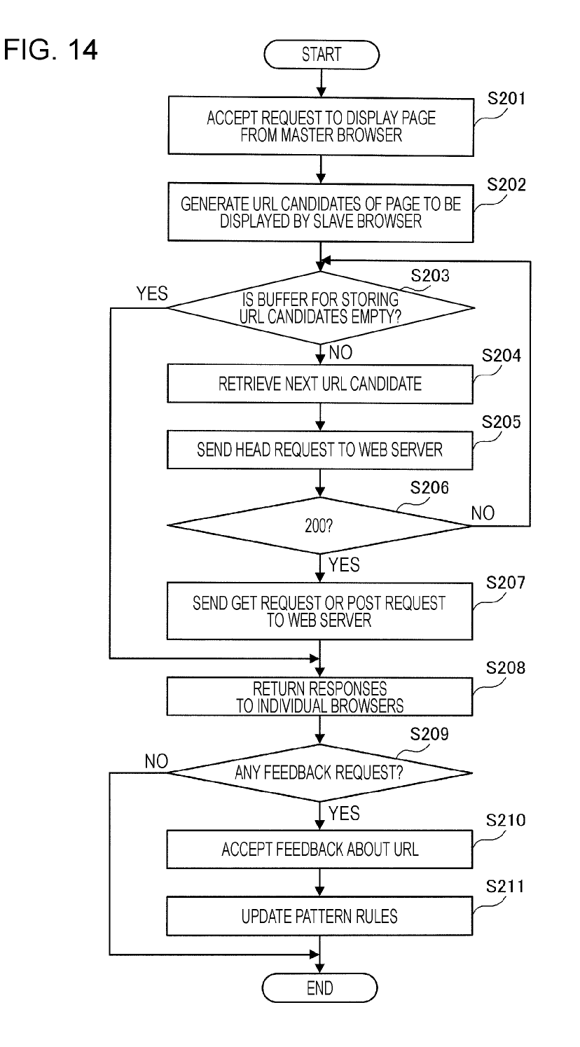

The aforementioned operations will now be described with reference to a flowchart. FIG. 14 is a flowchart showing operations of the agent 20 in response to a request from the master browser 11. In general, this process is repeated in response to each request from the master browser 11.

The operation is started when the browser management unit 21 first accepts a request to display a page from the master browser 11 (step S201). The request to display a page includes the URL of a page, as described above. In this case, the browser management unit 21 determines the language of a page to be displayed by the slave browser 12 with reference to the browser information storage unit 22. The browser management unit 21 further generates a URL conversion instruction to convert a corresponding URL to a URL in the determined language and sends the URL conversion instruction to the URL generating unit 23.

The URL generating unit 23, using pattern rules stored in the pattern rule storage unit 24, generates a list of URL candidates that includes candidates for the URL of a target page to be displayed by the slave browser 12 and transfers the list of URL candidates to the request/response management unit 25 (step S202).

The request/response management unit 25 checks the validity of each of the URLs on the list of URL candidates. Initially, it is determined whether a buffer that stores unprocessed URL candidates is empty (step S203).

When it is determined that the buffer is not empty, meaning there are one or more URL candidates that have yet to be processed, the next URL candidate is retrieved from the buffer (step S204). Then, a HEAD request is sent to the web server 30 using the retrieved URL candidate (step S205). It is determined whether the web server 30 returns a “200 OK” response, i.e., a normal response, in response to the HEAD request (step S206). When the web server 30 not return a normal response, the process returns to step S203, and it is again determined whether the buffer is empty. When the web server 30 returns a normal response, a GET request or a POST request is sent to the web server 30 using the URL retrieved in step S204 (step S207). Then, a response returned from the web server 30 is transferred to the browser management unit 21.

On the other hand, if it is determined in step S203 that the buffer is empty, the process proceeds directly to step S208. In this case, no normal response will have been provided for any of the URLs on the list of URL candidates. Information indicating this status is transferred to the browser management unit 21. The browser management unit 21 returns the transferred information to the master browser 11 and the slave browser 12 (step S208). Even when a normal response returned from the web server 30 is sent to the slave browser 12, the response may have an error. In the present embodiment, an arrangement is provided, in which, in such a case, a correct URL can be fed back, as described above.

Thus, the browser management unit 21 determines whether any feedback request exists (step S209). When no feedback request exists, the process is completed. On the other hand, when a feedback request exists, the browser management unit 21 accepts a correct URL from the slave browser 12 (step S210). Then, the browser management unit 21 sends a URL correction instruction to the URL generating unit 23, and the URL generating unit 23 updates pattern rules (step S211). The updated pattern rules will then be used in future iterations of step S202.

In the described embodiment, in which the role of the master browser is changed every time a page is requested, a request from a browser in which control acquisition is disabled is treated as a feedback request.

The detailed operations of generating a list of URL candidates in step S202 in the flowchart in FIG. 14 will now be described. In the present embodiment, the process of generating a URL candidates list includes first and second processes. The first process is employed to convert language information detected in individual elements of an original URL from expressions in a first or source language to corresponding expressions in the second or target language. As will be explained in more detail below, the first process is employed one element at a time for each of the elements of the original URL. The second process is employed to combine URL elements produced by the first process in different ways to generate different candidates to be included in the list of URL candidates. In the present embodiment, two types of pattern rules are used, i.e., conversion rules used in the first process and combination rules used in the second process. In carrying out the processes described above, it is assumed items of language information included in individual elements of a URL are independent of each other.

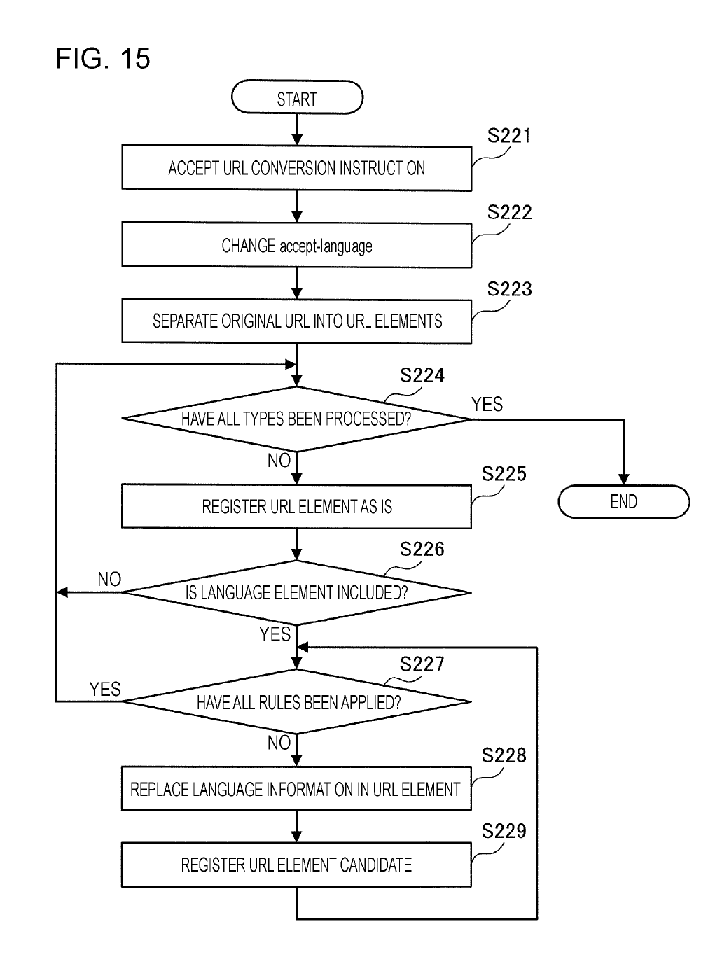

FIG. 15 is a flowchart showing an example of the first process in generating a list of URL candidates. The URL generating unit 23 first accepts a URL conversion instruction from the browser management unit 21 (step S221). A URL conversion instruction includes a URL (the original URL) transferred from the master browser 11 and language conversion information indicating which language is to be considered the source language and which language is to be considered the target language. An original URL includes a character string (one that is generally recognized as a URL) that typically includes a domain, a path, and a parameter (a query string). In the present embodiment, in addition to these items, the URL includes items of information, such as accept-language in an HTTP header, form data (hereinafter called POST data) sent to the web server 30 by the POST method, and a cookie.

The URL generating unit 23 changes a language set in accept-language included in the original URL on the basis of the language conversion information accepted in step S221 (step S222). In general, the language setting cannot be configured for each browser window. That is to say, when the language is changed in one of a plurality of concurrently open browser windows, the changed language setting applies to all of the other concurrently open browser windows in the set. Thus, in the present embodiment, the agent 20 overwrites the value of accept-language set on the basis of the language setting for a browser in a request issued by the browser.

The URL generating unit 23 parses or separates the original URL obtained in step S221 into identified elements, such as a domain, a path, a parameter, POST data, and a cookie (step S223). The following steps are performed on the each of the identified elements in the original URL.

Because the process is an iterative one, proceeding one URL element at a time, in initial determination is made whether all types of the URL elements have been processed (step S224) in the currently-considered URL. On the first pass through the process, the answer will, of course, be “No”.

On the first pass, a first URL element (for example, a domain name) of the URL accepted in step S221 is selected and registered As Is (without change) in a URL element candidates list (step S225). Hereinafter, it should be understood that an As Is URL candidate element is one that is identical to the corresponding element in the original URL. It can be expected that As Is URL elements will be frequently encountered since not every element in a URL will include language-related entries.

The URL generating unit 23 determines whether the first URL element includes language information (step S226). If the first URL element does not include language information, the process returns to step S224, and consideration of that element is considered complete as the element will have already been registered As Is in step S225. The process returns to step 224 and the same steps are performed on the next URL element in the original URL. Conversely, if the first URL element is found to include language-related information, the following steps are performed one or more times until all applicable conversion rules have been applied to the URL element under consideration.

The process described below is another iterative process in which an initial determination (step S227) is made whether all conversion rules applicable to the URL element under consideration have already been performed. On the first pass through the iterative process, that will, of course, not be the case. Assuming there are one or more conversion rules that are yet to be applied, one of those rules is selected (step S228) and the language information included in the first URL element is converted according to the currently selected conversion rule. The URL element resulting from this conversion is registered (step S229) in a list of candidates for the URL element and the process loops back to the input of step S227, where the next applicable conversion rule is selected and used to process the URL element under consideration. The loop is repeated until all the applicable conversion rules have been applied to the URL element under consideration.

When all of the applicable conversion rules have been applied, the list of candidates for the URL element under consideration is considered complete. The program loops back to the input of step S224, where a determination is made whether there are still other unprocessed URL elements in the original URL. If unprocessed URL elements remain, the next element is selected and the process described above is repeated. If all URL elements in the URL have been processed (indicated by a “Yes” response in Step S224, the process ends.

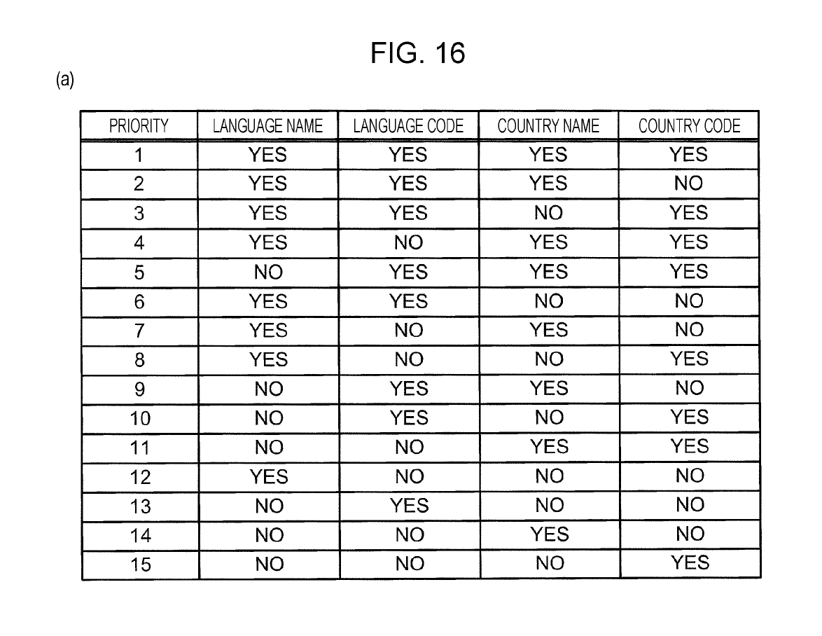

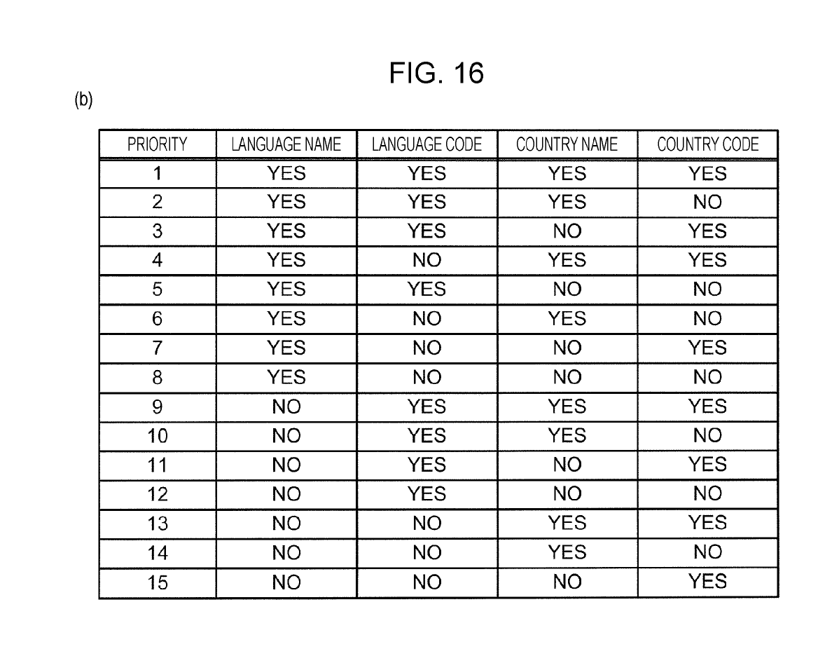

The above-described operations will now be applied using a specific example. Conversion rules used in the specific example will first be described. FIG. 16 shows examples of conversion rules that could be stored in the pattern rule storage unit 24.

The stored conversion rules identify which character strings found in an original URL element are to be modified or converted, together with the priority for performing those conversion. In the present embodiment, character strings representing a language name (e.g., Japanese), a language code (e.g., JA), a country name (e.g., Japan), and a country code (e.g., JP) are all considered URL element items or character strings that are candidates for conversion to data associated with a different language or country. For example, the language name “Japanese” is a considered as a candidate for conversion to the language name “English” in accordance with the present invention. Different priority levels are assigned to converting different sets of such items. In the drawing, “YES” indicates that a corresponding item of language information is to be converted at a particular priority level while “NO” indicates that a corresponding item of language information is not to be converted at that particular priority level.

The shorter the typical character string of an item of language information, the lower the probability that the item of language information would need to be replaced. Put differently, the longer the typical character string of an item of language information, the higher the priority for replacement should be. For example, comparing the country name with the language name often shows that the language name is longer than the country name. Thus, in FIG. 16, the priorities are assigned to conversions of the language name, the language code, the country name, and the country code in this order. However, if the country name is longer than the language name, the priority order will be different.

There are other bases for determining which URL element candidate should be given higher priority for conversions. One basis would be to give the highest priority conversion to URL elements containing the greatest number of language components that need to be converted.

FIG. 16(a) shows conversion rules based on this idea. Highest priority is given where all four items or character strings (language name, language code, country name and country code) are to be replaced. The next highest priority (priority levels 2-5) is given where three items are to be replaced. The next highest priority (priority levels 6-11) is given where only two items are to be replaced and lowest priority (priority levels 12-15) is given where only one item in the URL element needs to be replaced.

Another basis for establishing priority is to give different weights to different language items in an element. FIG. 16(b) shows conversion rules based on this basis. For the first to eighth priorities, “YES” corresponds to the language name. For the ninth to twelfth priorities, “NO” corresponds to the language name, and “YES” corresponds to the language code. For the thirteenth and fourteenth priorities, “NO” corresponds to the language name and the language code, and “YES” corresponds to the country name. For the fifteenth priority, “YES” corresponds only to the country code.

Actual conversion of a URL using the conversion rules in FIG. 16(a) will now be described. It is assumed that the original URL obtained in step S221 is “http://ja.foobar.com/ja_JP/document/release_note_japanese.html”. It is also assumed that the original URL is to be converted to a URL that reflects French country/language components.

In step S223, a domain element “ja.foobar.com” and a path element “ja_JP/document/release_note_japanese.html” are identified and extracted from the original URL.

Analysis of the domain element shows that element includes only the language code “ja” which means that a conversion rule with the thirteenth priority in the table in FIG. 16(a) needs to be applied.

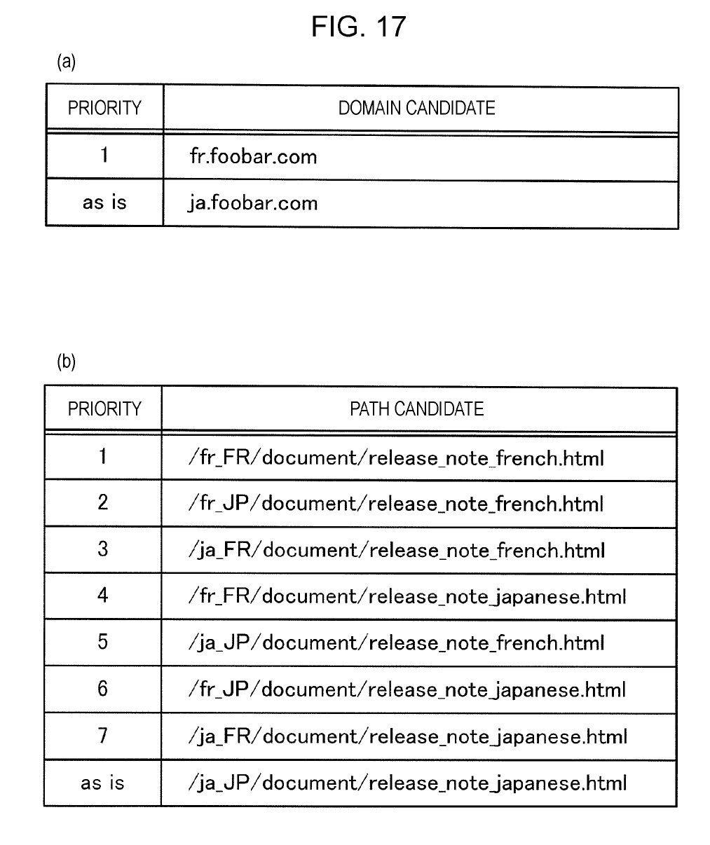

FIG. 17(a) shows candidates for a domain element (domain element candidates) resulting from applying the conversion rule to the domain element from the original URL. In this case, there are only two candidates. The first candidate “fr.foobar.com” results from translating the original language code “ja” to “fr” while the second candidate results from the described As Is registration of the original domain element.

Next, the conversion of the path element “ja_JP/document/release_note_japanese.html” will be described. The path element includes a language name “japanese”, a language code “ja”, and a country code “JA”. Multiple conversion rules need to applied in order. Specifically, conversion rules with the third, sixth, eighth, tenth, twelfth, thirteenth, and fifteenth priorities are applied in order so as to generate a list of URL element candidates for the path element (path candidates). Applying the conversion rule with the third priority will result in all of the language name, the language code, and the country code being converted. Specifically, the language name “japanese” is converted to “french”, the language code “ja” is converted to “fr”, and the country code “JP” is converted to “FR” to produce the path candidate with the first priority in FIG. 17(b). Path candidates with the second to seventh priorities in FIG. 17(b) are generated by applying the other applicable conversion rules in the same manner. In this case, the lowest priority is assigned to the “as is” path element candidate registered as is in step S225.

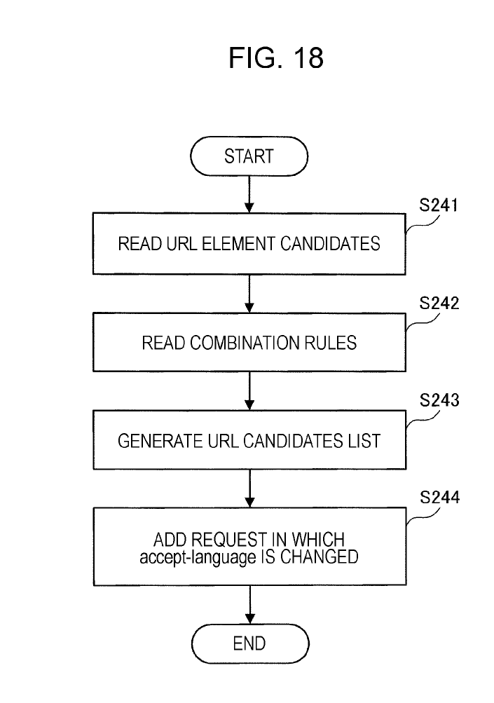

FIG. 18 is a flowchart showing an example of the second process in generating a URL candidates list based on combinations of URL element candidates generated in the manner described above. The URL generating unit 23 first reads URL element candidates, for example, candidates for a domain element, candidates for a path element, and candidates for a parameter element (step S241). The URL generating unit 23 then reads combination rules for combining these URL element candidates from the pattern rule storage unit 24 (step S242). A definitive list of URL candidates is generated by applying the combination rules read in step S242 to the individual URL element candidates read in step S241 (step S243). A request in which accept-language is changed in step S222 in FIG. 15 is inserted just before the last candidate of the list generated in step S243, and the results are set as all URL candidates (step S244).

The aforementioned operations will now be described using a specific example. Combination rules used in this example will first be described.

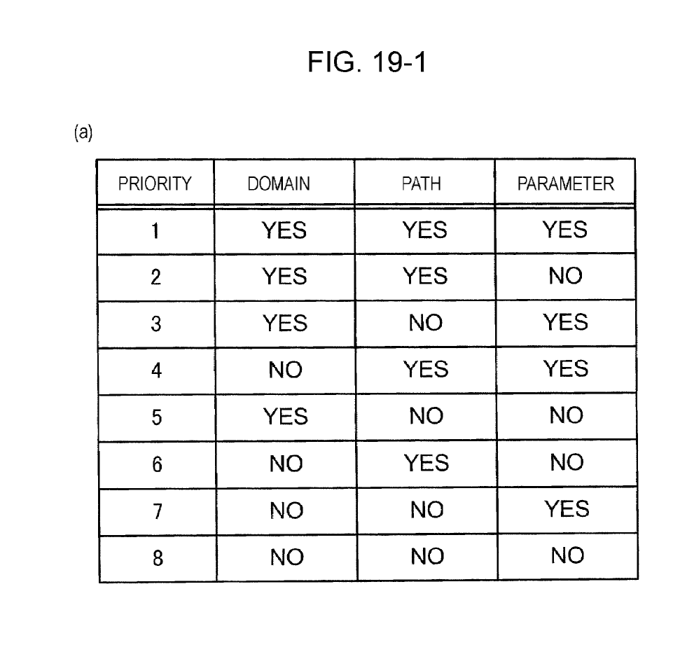

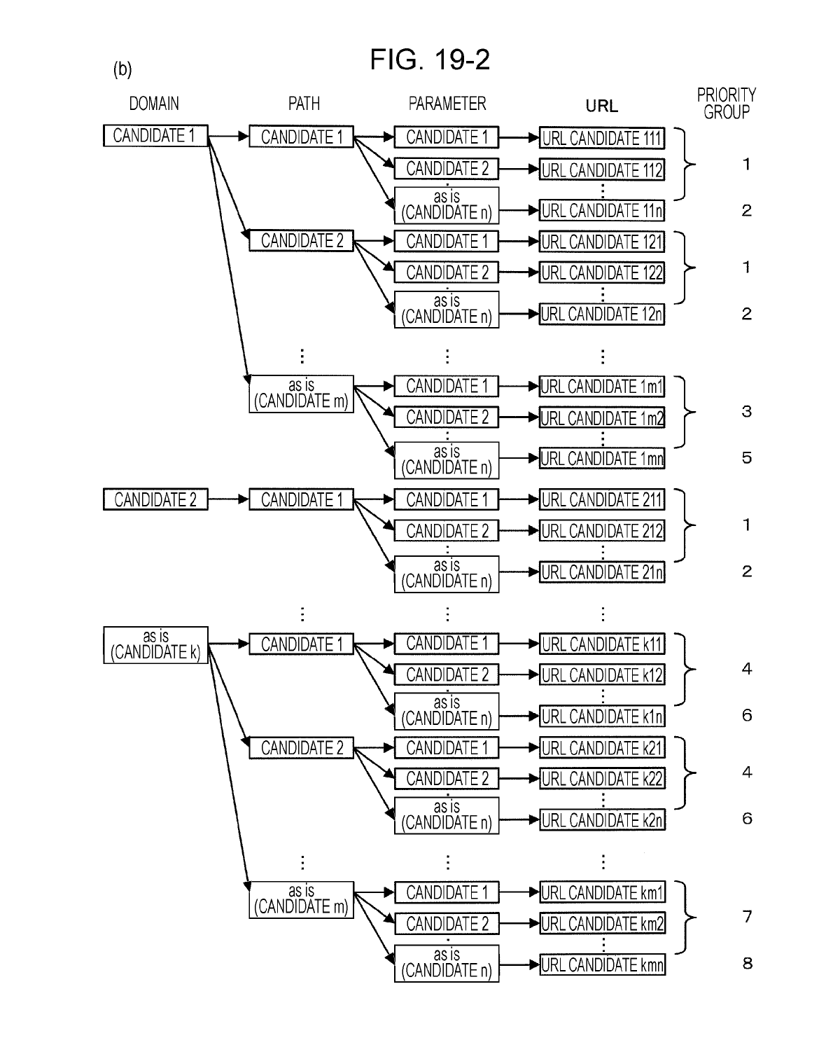

FIG. 19-1(a) shows examples of combination rules stored in the pattern rule storage unit 24. Each combination rule shows which URL elements are combined to generate a URL. In this case, a domain element, a path element, and a parameter element are assumed to be URL elements. In the drawing, “YES” indicates that the result of language conversions of the associated URL element are to be incorporated into a combination while “NO” indicates that the result of language conversions of the associated URL element are not incorporated into a combination.

FIG. 19-2(b) shows URL candidates that can result from application of the combination rules. All combinations of k candidates for a domain element, m candidates for a path element, and n candidates for a parameter element are first listed in order. Specifically, a URL candidate 111, a URL candidate 112, . . . , and a URL candidate kmn are generated. In the example shown in FIG. 19-2(b), the combinations are listed, assuming that the priorities are assigned to a domain, a path, and a parameter in this order. Then, URL candidates with the same priority are combined into a group according to the priorities in the table in FIG. 19-1(a). Specifically, the URL candidate 111 belongs to a group with the first priority, and a URL candidate 11n belongs to a group with the second priority. In the same group, the order in which the combinations are listed is inherited. Specifically, the smaller a number suffixed to a URL candidate, the higher the priority of the URL candidate. Thus, in a priority group 1, the priority of the candidate 111 is higher than the priority of a URL candidate 121.

Actual generation of URLs using the combination rules in FIG. 19-1(a) will now be described. It is assumed that the candidates for a domain element shown in FIG. 17(a) and the candidates for a path element shown in FIG. 17(b) are read in step S241. Since no parameter element exists, combination rules with the second, fifth, and sixth priorities in FIG. 19-1(a) are applied in order.

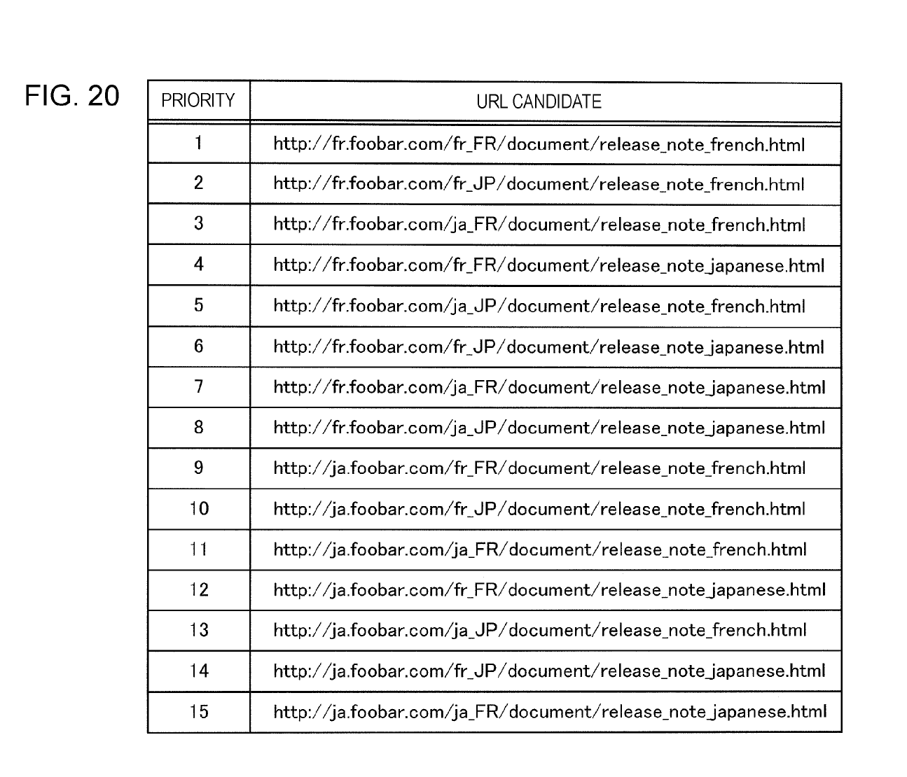

FIG. 20 shows a generated list of URL candidates.

Entries with the first to seventh priorities in the URL candidates list in FIG. 20 are generated by applying the combination rule with the second priority in FIG. 19-1(a). An entry with the eighth priority in the URL candidates list in FIG. 20 is generated by applying the combination rule with the fifth priority in FIG. 19-1(a). Entries with the ninth to fifteenth priorities in the URL candidates list in FIG. 20 are generated by applying the combination rule with the sixth priority in FIG. 19-1(a). Finally, an entry generated in step S244 and the last URL candidate kmn in FIG. 19-2(b) follow.

In the present embodiment, a master-slave relationship is introduced in browsers, and the agent 20 manages the master browser 11 and the slave browser 12, as described above. Pages with the same content in different languages are synchronized and displayed in a plurality of browser windows in which the language settings different from the original language setting are configured by issuing, to the web server 30, a URL request generated by processing the language settings configured in the browser windows by the agent 20. This enables operations on browser windows such that, for example, when a Japanese page is opened, a corresponding English page is automatically opened, and when a location of a Japanese page is changed, a corresponding location of an English page is automatically changed.

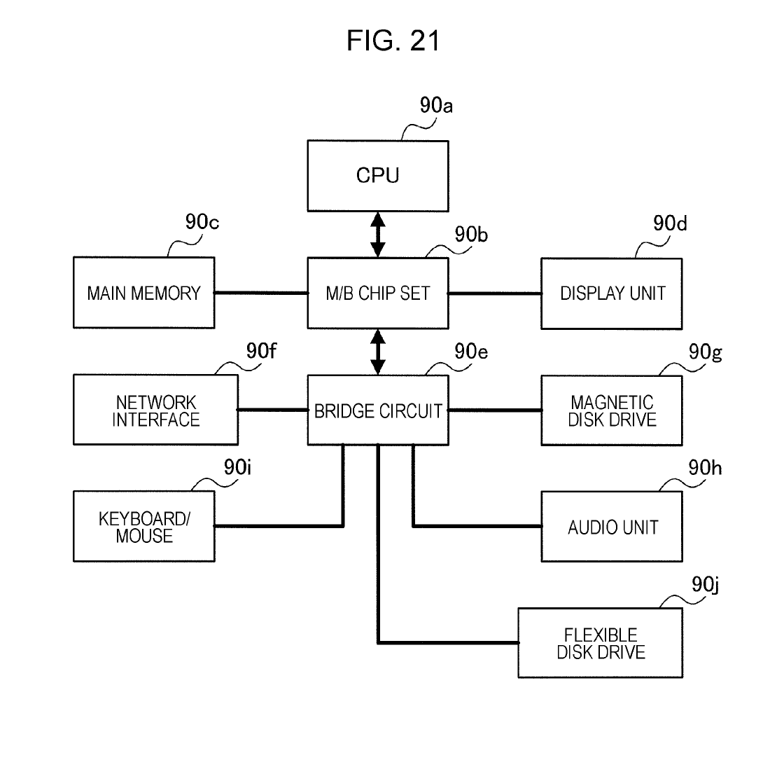

Finally, the hardware configuration of a computer suitable for implementing the present embodiment will be described. FIG. 21 shows an example of the hardware configuration of such a computer. The computer includes a central processing unit (CPU) 90a that is calculation means, a main memory 90c connected to the CPU 90a via a mother board (M/B) chip set 90b, and a display unit 90d connected to the CPU 90a via the M/B chip set 90b, as shown in the drawing. Moreover, a network interface 90f, a magnetic disk drive (HDD) 90g, an audio unit 90h, a keyboard/mouse 90i, and a flexible disk drive 90j are connected to the M/B chip set 90b via a bridge circuit 90e.

In FIG. 21, the individual components are connected to each other via a bus. For example, connection between the CPU 90a and the M/B chip set 90b and connection between the M/B chip set 90b and the main memory 90c are established via a CPU bus. Moreover, connection between the M/B chip set 90b and the display unit 90d may be established via Accelerated Graphics Port (AGP). However, when the display unit 90d includes a video card that supports PCI Express, connection between the M/B chip set 90b and this video card is established via a PCI Express (PCIe) bus. Moreover, when connection to the bridge circuit 90e is established, regarding the network interface 90f, for example, PCI Express may be used. Moreover, regarding the magnetic disk drive 90g, for example, serial AT Attachment (ATA), ATA for parallel transfer, or Peripheral Components Interconnect (PCI) may be used. Moreover, regarding the keyboard/mouse 90i and the flexible disk drive 90j, Universal Serial Bus (USB) may be used.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented apparatus for controlling display of related documents using different languages comprising:
an accepting unit for receiving a first document identifier from a first client, said first document identifier including language-related components associated with a first language;
an obtaining unit for processing said language-related components in said first document identifier to generate a second document identifier including language-related components associated with a second language;
a control unit for retrieving, for display at a second client, a second document identified by the generated second document identifier.

2. A computer-implemented apparatus according to claim 1, wherein said obtaining unit processes a said language-related component by replacing at least one character string associated with the first language with a character string associated with the second language.

3. A computer-implemented apparatus according to claim 2, wherein the obtaining unit generates a list of candidate second document identifiers by replacing multiple character strings found in different elements of the first document identifier.

4. A computer-implemented apparatus according to claim 3, wherein the obtaining unit further attempts to find a stored document associated with each candidate second document identifier included in the list.

5. A computer-implemented apparatus according to claim 4 wherein the control unit retrieves one of the stored documents found by the obtaining unit.

6. A computer-implemented apparatus according to claim 5 wherein said first document identifier and said second document identifier each comprises a Universal Resource Locator having one or more elements each comprising at least one character string associated with one of said first language or said second language.

7. A computer-implemented apparatus according to claim 6 wherein said first document identifier and said second document identifier each comprises a Universal Resource Locator having one or more elements further comprising character strings associated with one or more of a language code, a country name or a country code.

8. A computer-implemented method for controlling the display of related documents using different languages comprising:
receiving a first document identifier from a first client, said first document identifier including language-related components associated with a first language;
processing language-related components in said first document identifier to generate a second document identifier including language-related components associated with a second language; and
retrieving, for display at a second client, a second document identified by the generated second document identifier.

9. A computer-implemented method according to claim 8 wherein processing language-related components in said first document identifier further comprises replacing at least one character string associated with the first language with a character string associated with the second language.

10. A computer-implemented method according to claim 9 further comprising generating a list of candidate second document identifiers by replacing multiple character strings found in different elements of the first document identifier.

11. A computer-implemented method according to claim 10 further comprising attempting to find a stored document associated with each candidate second document identifier included in the list.

12. A computer-implemented method according to claim 10 wherein retrieving, for display at a second client, a second document further comprises retrieving one of the stored documents.

13. A computer-implemented method according to claim 12 wherein said first document identifier and said second document identifier each comprises a Universal Resource Locator having one or more elements each comprising at least one character string associated with one of said first language or said second language.

14. A computer program product for controlling the display of related documents using different languages, said computer program product comprising a computer usable medium having computer usable program code embodied therewith, said computer usable program code comprising:
computer usable program code configured to receive a first document identifier from a first client, said first document identifier including language-related components associated with a first language;
computer usable program code configured to process language-related components in said first document identifier to generate a second document identifier including language-related components associated with a second language; and
computer usable program code configured to retrieve, for display at a second client, a second document identified by the generated second document identifier.

15. A computer program product according to claim 14 wherein computer usable program code configured to process language-related components in said first document identifier further comprises computer usable program code configured to replace at least one character string associated with the first language with a character string associated with the second language.

16. A computer program product according to claim 15 further comprising computer usable program code configured to generate a list of candidate second document identifiers by replacing multiple character strings found in different elements of the first document identifier.

17. A computer program product according to claim 16 further comprising computer usable program code configured to attempt to find a stored document associated with each candidate second document identifier included in the list.

18. A computer program product according to claim 17 wherein computer usable program code configured to retrieve, for display at a second client, a second document further comprises computer usable program code configured to retrieve one of the stored documents.

19. A computer program product according to claim 18 wherein said first document identifier and said second document identifier each comprises a Universal Resource Locator having one or more elements, each comprising at least one character string associated with one of said first language or said second language.

20. A computer program product according to claim 19 wherein said first document identifier and said second document identifier each comprises a Universal Resource Locator having one or more elements further comprising character strings associated with one or more of a language code, a country name or a country code.
